(19) United States
(12) Patent Application Publication
(10) Pub. No.: US 2025/0353236 A1
(43) Pub. Date: Nov. 20, 2025

(54) MULTILAYER POLYIMIDE FILM AND METHOD FOR MANUFACTURING SAME

(71) Applicant: PI ADVANCED MATERIALS CO., LTD., Chungcheongbuk-do (KR)

(72) Inventors: Sung-Yul BACK, Seoul (KR); Kil-Nam LEE, Bucheon-si (KR); Min-Sang CHO, Incheon (KR)

(73) Assignee: PI ADVANCED MATERIALS CO., LTD., Chungcheongbuk-do (KR)

(21) Appl. No.: 18/713,617

(22) PCT Filed: Nov. 23, 2022
(86) PCT No.: PCT/KR2022/018621

§ 371 Date: Dec. 4, 2024

(30) Foreign Application Priority Data
Nov. 24, 2021 (KR) 10-2021-0163035

(51) Int. Cl. B29C 48/08; B29C 35/02; B29C 48/00; B29C 48/21; B29C 48/78; B29C 71/00; B29K 79/00; C08G 73/10

(52) U.S. Cl. CPC B29C 48/08; B29C 35/02; B29C 48/022; B29C 48/21; B29C 48/78; B29C 71/00; B29K 2079/08; B29K 2995/0097; C08G 73/1042; C08G 73/1067

(57) ABSTRACT

The present invention provides a multilayer polyimide film and a method for manufacturing same, the multilayer polyimide film comprising at least one skin layer, which is formed on at least one outer surface of a core layer, and having a dielectric dissipation factor of 0.003 or less and an adhesive force of 1,000 gf/cm or more.

### TECHNICAL FIELD

The present disclosure relates to a multilayer polyimide film having excellent low-dielectric and adhesive properties and a method of forming the same.

### BACKGROUND ART

Polyimide (PI) is a polymeric material having the highest level of heat resistance, chemical compatibility, electrical insulation, chemical resistance, and weather resistance of all organic materials on the basis of an imide ring having excellent chemical stability along with a rigid aromatic main chain.

Additionally, polyimide is attracting attention as a highly functional polymer material in microelectronic and optical fields due to having excellent electrical properties, such as insulation properties and a low dielectric constant.

For example, in microelectronic fields, flexible thin circuit boards with high integration density are being actively developed due to weight reduction and size reduction in electronic products. These thin circuit boards tend to have a structure, being widely used, in which a circuit including a metal foil is formed on a polyimide film having excellent heat resistance, low-temperature resistance, and insulation properties while being easily bendable. Such a thin circuit board is referred to as a flexible metal-clad laminate in a broad sense and, as one example thereof in a narrower sense, is also referred to as a flexible copper-clad laminate (FCCL) when using a thin copper plate as a metal foil. Furthermore, polyimide is also used in protective films, insulating films, and the like for thin circuit boards.

Methods of forming a flexible metal-clad laminate may, for example, include (i) a casting method in which a polyamic acid, a precursor of polyimide, is cast or applied onto a metal foil and then imidized, (ii) a metalizing method in which a metal layer is directly installed on a polyimide film through sputtering or plating, and (iii) a laminate method in which a polyimide film and a metal foil are bonded using heat and pressure through a thermoplastic polyimide.

Among these, the laminate method has advantages in that the thickness range of the applicable metal foil is broader than that in the casting method, and the equipment costs less than that in the metalizing method. As laminating equipment, roll laminating equipment to feed and continuously laminate roll-type materials, double belt press equipment, or the like is used. When it comes to productivity, a thermal roll laminate method using thermal roll laminating equipment from the above is further preferably used.

However, as mentioned above, a thermoplastic resin is used for adhesion between the polyimide film and the metal foil in laminating. For this reason, to develop the thermal fusibility of the thermoplastic resin, heat at a temperature of 300° C. or higher or 400° C. or higher, nearly the glass transition temperature (Tg) of the polyimide film or higher in some cases, is required to be applied to the polyimide film.

Typically, it is known that the storage modulus value of a viscoelastic body such as a polyimide film decreases significantly in a temperature range beyond the glass transition temperature compared to the value thereof at room temperature.

That is to say, during laminating that requires high temperatures, the storage modulus of a polyimide film at high temperatures may decrease significantly. Additionally, under the low storage modulus, the polyimide film loosens and is highly unlikely to be present in a planarized form after the completion of laminating. In other words, the dimensional change of the polyimide film in the case of laminating may be relatively unstable.

Another to be noted is the case where the glass transition temperature of the polyimide film is significantly lower than a laminating temperature. Specifically, the viscosity of the polyimide film is relatively high at the laminating temperature, which may involve a relatively significant dimensional change, and deterioration in the appearance quality of the polyimide film after laminating is thus a concern.

Therefore, there is a growing need for technology capable of significantly improving processability by solving the problems above.

On the other hand, with various built-in functions in electronic devices, there has recently been a growing demand for applying fast calculation and communication speeds to such devices. Thin circuit boards capable of high-speed communication based on a low dielectric dissipation factor even at high frequencies of 10 GHz or higher are being developed to meet such a demand.

To realize high-speed communication at high frequencies, an insulator with a high impedance capable of maintaining electrical insulation properties even at high frequencies is required.

Impedance is inversely proportional to the dielectric constant (Dk) and frequency formed in the insulator, so the dielectric constant must be as low as possible to maintain insulation properties even at high frequencies.

However, typical polyimide has a dielectric constant at a level of about 3.4 to 3.6, which is not excellent enough to maintain sufficient insulation properties in high-frequency communication. For example, there is a possibility of partially or entirely losing the insulation properties in thin circuit boards where communication occurs at high frequencies of 10 GHz or higher.

Additionally, it is known that when an insulator has a low dielectric constant, the stray capacitance and noise, undesirably occurring in thin circuit boards, are likely to be reduced, thereby eliminating most of the causes of communication delays. Thus, keeping the dielectric constant of polyimide as low as possible is recognized as the most important factor in the performance of thin circuit boards.

Another to be noted is that dielectric dissipation inevitably occurs through polyimide when communication occurs at high frequencies of 10 GHz or higher.

A dielectric dissipation factor (Df) refers to the degree of electrical energy wasted in a thin circuit board and is closely related to signal transmission delays that determine communication speed. Thus, keeping the dielectric dissipation factor of polyimide as low as possible is also recognized as an important factor in the performance of thin circuit boards.

Accordingly, there is a need to develop a polyimide film having a relatively low dielectric dissipation factor and high adhesive strength to enable stable circuit implementation and an effective method of forming the same.

The foregoing background description is intended to provide an understanding of the background of the present disclosure and may include matters not known in the related art to those skilled in the field to which the technology belongs.

### DOCUMENT OF RELATED ART

### Patent Document

(Patent Document 1) Korean Patent Application Publication No. 10-2012-0133807

### DISCLOSURE

### Technical Problem

One objective, according to one aspect of the present disclosure, is to provide a multilayer polyimide film having excellent adhesive strength and a relatively low dielectric dissipation factor and an effective method of forming the same and, specifically, aims to provide a polyimide film having excellent adhesive strength and a low dielectric dissipation value even at high frequencies by determining the type of acid dianhydride, the type of diamine, and a mixing ratio thereof and also forming polyimide resins that differ in composition into multiple layers.

Another objective, according to another aspect of the present disclosure, is to provide a flexible copper-clad laminate including a multilayer polyimide film having excellent adhesive strength and a relatively low dielectric dissipation factor to be effective in high-speed transmission and high-speed communication at high frequencies.

Hence, the present disclosure aims to practically provide specific embodiments thereof.

However, the problems to be solved by the present disclosure are not limited to the above description, and other problems can be clearly understood by those skilled in the art from the following description.

### Technical Solution

In one aspect of the present disclosure for achieving the objectives described above, a multilayer polyimide film including a core layer and one or more skin layers formed on one or more outer surfaces of the core layer,
wherein a dielectric dissipation factor is 0.003 or less, and an adhesive strength is 1,000 gf/cm or more,
is provided.

In another aspect of the present disclosure, a flexible metal-clad laminate including the multilayer polyimide film and an electrically conductive metal foil
is provided.

In a further aspect of the present disclosure, an electronic component including the flexible metal-clad laminate
is provided.

### Advantageous Effects

The present disclosure provides a polyimide film in which the composition ratio, reaction ratio, and the like of acid dianhydride and diamine components are adjusted, thereby providing a polyimide film having both excellent low-dielectric and adhesion properties.

Another objective, according to another aspect of the present disclosure, is to provide a flexible copper-clad laminate including a multilayer polyimide film having excellent adhesive strength and a relatively low dielectric dissipation factor to be effective in high-speed transmission and high-speed communication at high frequencies.

### BEST MODE

All terms including technical and scientific terms used herein have the same meaning as commonly understood by those skilled in the art to which the present disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

Therefore, the embodiments described herein are merely examples and do not exhaustively present the technical spirit of the present disclosure. Accordingly, it should be appreciated that there may be various equivalents and modifications that can replace the embodiments and the configurations at the time at which the present application is filed.

As used herein, the singular forms are intended to include the plural forms as well, unless the context clearly indicates otherwise. It will be further understood that the terms “comprise”, “include”, “have”, and the like when used herein, specify the presence of stated features, integers, steps, components, or combinations thereof but do not preclude the presence or addition of one or more other features, integers, steps, components, or combinations thereof.

As used herein, although the term “acid dianhydride” is intended to include precursors or derivatives thereof, these compounds may not technically be acid dianhydride. Nevertheless, these compounds will react with diamine to form polyamic acids, which will be converted to polyimides once more.

As used herein, although the term “diamine” is intended to include precursors or derivatives thereof, these compounds may not technically be diamines. Nevertheless, these compounds will react with dianhydride to form polyamic acids, which will be converted to polyimides once more.

When an amount, concentration, other value, or parameter is given herein as a range, preferred range, or enumeration of preferred upper values and preferred lower values, it is to be understood to specifically disclose all ranges formed by pairing any upper range limit or a preferred value with any lower range limit or a preferred value, regardless of whether the ranges are additionally disclosed.

When a range of numerical values is mentioned herein, this range is intended to include not only the endpoints but also all integers and fractions within the range, unless otherwise stated. The scope of the present disclosure is not intended to be limited to the specific values mentioned when defining the scope.

A multilayer polyimide film, according to one embodiment of the present disclosure, includes a core layer and one or more skin layers formed on one or more outer surfaces of the core layer, wherein a dielectric dissipation factor may be 0.003 or less, and an adhesive strength may be 1,000 gf/cm or more.

In one embodiment, the multilayer polyimide film may include the skin layers formed respectively on first and second outer surfaces of the core layer, the second outer surface being a surface opposite to the first outer surface, to have a three-layer structure.

The skin layers formed respectively on the first and second outer surfaces of the core layer, the second outer surface being the surface opposite to the first outer surface, may be the same or differ in dianhydride and diamine components and composition ratio thereof.

Additionally, the skin layers formed respectively on the first and second outer surfaces of the core layer, the second outer surface being the surface opposite to the first outer surface, may be the same or differ in thickness.

In one embodiment, the three-layer structured polyimide film may have a total thickness of 10 μm or larger and 100 μm or smaller, the core layer may have a thickness being 70% or more and 95% or less of the total thickness of the multilayer polyimide film, and the skin layers formed respectively on the first and second outer surfaces of the core layer, the second outer surface being the surface opposite to the first outer surface, may have a total thickness being 5% or more and 30% or less of the total thickness of the multilayer polyimide film.

For example, the core layer may have a thickness of 35 μm or larger and 45 μm or smaller, and one of the skin layers may have a thickness of 2.5 μm or larger and 7.5 μm or smaller.

When the thickness of the core layer and/or the skin layer is larger or smaller than the above range, the dielectric dissipation factor of the multilayer polyimide film may increase, leading to deterioration in low-dielectric properties or a decrease in adhesive strength.

In one embodiment, the core layer may be obtainable by reacting a polyamic acid solution through an imidization reaction, the polyamic acid solution containing an acid dianhydride component including biphenyl-tetracarboxylic dianhydride (BPDA) and pyromellitic dianhydride (PMDA) and a diamine component including para-phenylenediamine (PPD) and m-tolidine.

Additionally, the skin layer may be obtainable by reacting a polyamic acid solution through an imidization reaction, the polyamic acid solution containing an acid dianhydride component including biphenyl-tetracarboxylic dianhydride and pyromellitic dianhydride and a diamine component including para-phenylenediamine, m-tolidine, and oxydianiline (ODA).

In one embodiment, in the core layer, the biphenyl-tetracarboxylic dianhydride may have a content of 50 mol % or more and 70 mol % or less, and the pyromellitic dianhydride may have a content of 30 mol % or more and 50 mol % or less, based on 100 mol % of the total content of the acid dianhydride component. Additionally, the para-phenylenediamine may have a content of 60 mol % or more and 80 mol % or less, and the m-tolidine may have a content of 20 mol % or more and 40 mol % or less, based on 100 mol % of the total content of the diamine component.

In one embodiment, the core layer may include a block copolymer containing two or more blocks.

The block copolymer of the core layer may include: a first block containing 50 mol % or more and 60 mol % or less of the biphenyl-tetracarboxylic dianhydride based on 100 mol % of the total content of the dianhydride component in the polyimide film; and a second block containing 30 mol % or more and 40 mol % or less of the m-tolidine based on 100 mol % of the total content of the diamine component in the polyimide film.

The first block may be obtainable by reacting biphenyl-tetracarboxylic dianhydride and para-phenylenediamine through an imidization reaction, and the second block may be obtainable by reacting m-tolidine and pyromellitic dianhydride through an imidization reaction.

Additionally, biphenyl-tetracarboxylic dianhydride in the first block may be imidized completely with para-phenylenediamine, and m-tolidine in the second block may be imidized completely with pyromellitic dianhydride.

In one embodiment, in the skin layer, the biphenyl-tetracarboxylic dianhydride may have a content of 30 mol % or more and 50 mol % or less, and the pyromellitic dianhydride may have a content of 50 mol % or more and 70 mol % or less, based on 100 mol % of the total content of the acid dianhydride component. Additionally, the para-phenylenediamine may have a content of 5 mol % or more and 25 mol % or less, the m-tolidine may have a content of 60 mol % or more and 80 mol % or less, and the oxydianiline may have a content of 5 mol % or more and 25 mol % or less, based on 100 mol % of the total content of the diamine component.

In the present disclosure, with the increasing content of para-phenylenediamine, a rigid monomer, the polyimide synthesized has a further linear structure and contributes to the improvement of the mechanical properties of the polyimide.

Additionally, m-tolidine has a particularly hydrophobic methyl group and thus contributes to the low hygroscopicity related to the dimensional stability of the polyimide film against moisture.

The polyimide chain of the present disclosure, derived from biphenyl-tetracarboxylic dianhydride, has a structure called a charge transfer complex (CTC), that is, a regular linear structure in which an electron donor and an electron acceptor are positioned close to each other, and the intermolecular interaction is strengthened.

Such a structure is effective in preventing hydrogen bonding with moisture and thus has an impact on reducing the moisture absorption rate, thereby maximizing the effect of reducing the hygroscopicity, which affects the dimensional stability against moisture, of the polyimide film.

Additionally, pyromellitic dianhydride, the acid dianhydride component having a relatively rigid structure, is preferable in terms of providing appropriate elasticity to the polyimide film.

The content ratio of the acid dianhydride is important for the polyimide film to have excellent dimensional stability. For example, as the content ratio of biphenyl-tetracarboxylic dianhydride decreases, a low moisture absorption rate based on the CTC structure is hard to expect, and the dimensional stability against moisture is reduced.

Additionally, while biphenyl-tetracarboxylic dianhydride contains two benzene rings corresponding to the aromatic moiety, pyromellitic dianhydride contains one benzene ring corresponding to the aromatic moiety.

The increase in the pyromellitic dianhydride content in the acid dianhydride component may be understood as an increase in the imide group within the molecule based on the same molecular weight, indicating that the ratio of the imide group derived from the pyromellitic dianhydride in the polyimide polymer chain increases relatively compared to that of the imide group derived from biphenyl-tetracarboxylic dianhydride.

In other words, an increase in the pyromellitic dianhydride content may be seen as a relative increase in the imide group in the entire polyimide film, making it difficult to expect high dimensional stability against moisture due to a low moisture absorption rate.

On the contrary, when the content ratio of pyromellitic dianhydride decreases, this means that the component having a relatively rigid structure is reduced, so the elasticity of the polyimide film may deteriorate below the desired level.

For this reason, when the biphenyl-tetracarboxylic dianhydride content is higher than the above range, or the pyromellitic dianhydride content is lower than the above range, the dimensional stability of the polyimide film may be reduced.

On the contrary, when the biphenyl-tetracarboxylic dianhydride content is lower than the above range, or the pyromellitic dianhydride content is higher than the above range, the dimensional stability of the polyimide film may be adversely affected.

The preparation of the polyamic acid in the present disclosure may, for example, involve:
(1) a polymerization method by adding the entire amount of the diamine component in a solvent and then adding the acid dianhydride component so that the amount thereof is substantially equimolar to that of the diamine component;
(2) a polymerization method by adding the entire amount of the acid dianhydride component in a solvent and then adding the diamine component so that the amount thereof is substantially equimolar to that of the acid dianhydride component;
(3) a polymerization method by adding some of the diamine component to a solvent, mixing some of the acid dianhydride component in a ratio of about 95 to 105 mol % to the reaction component, adding the remaining diamine component, and then subsequently adding the remaining acid dianhydride component so that the diamine component and the acid dianhydride component are substantially equimolar;
(4) a polymerization method by adding some of the acid dianhydride component to a solvent, mixing some of the diamine compound in a ratio of about 95 to 105 mol % to the reaction component, adding the remaining acid dianhydride component, and then subsequently adding the remaining diamine component so that the diamine component and the acid dianhydride component are substantially equimolar;
(5) a polymerization method by reacting some of the diamine component and some of the acid dianhydride component in a first solvent so that either one is in excess to form a first composition, reacting some of the diamine component and some of the acid dianhydride component in a second solvent so that either one is in excess to form a second composition, and mixing the first and second compositions to complete polymerization, wherein when the diamine component is in excess when forming the first composition, the acid dianhydride component in the second composition is contained in an excessive amount, and when the acid dianhydride component is in excess in the first composition, the diamine component in the second composition is contained in an excessive amount to mix the first and second compositions so that the entire diamine component and acid dianhydride component used in the reaction are substantially equimolar; and the like.

In the present disclosure, such a polymerization method of the polyamic acid described above may be defined as a random polymerization method. Additionally, the polyimide film of the present disclosure, formed from the polyamic acid prepared through such a process described above, is preferably applicable for maximizing the effect of the present disclosure in reducing the dimensional stability and chemical resistance.

However, the polymerization method makes the length of the repeating unit in the polymer chain described above relatively short, so there may be limitations in demonstrating each of the excellent properties of the polyimide chain derived from the acid dianhydride component. Therefore, block polymerization may be performed as the polymerization method of the polyamic acid, which is further preferably usable in the present disclosure.

On the other hand, the solvent for synthesizing the polyamic acid is not particularly limited, and any solvent capable of dissolving the polyamic acid may be usable. However, an amide-based solvent is preferably used.

Specifically, the organic solvent may be a polar organic solvent, which may be, in particular, a polar aprotic solvent. Examples thereof may include one or more selected from the group consisting of N,N-dimethylformamide (DMF), N,N-dimethylacetamide, N-methyl-pyrrolidone (NMP), gamma-butyrolactone (GBL), and diglyme, but the solvent is not limited thereto. If necessary, the solvent may be used alone, or two or more types may be used in combination.

In one example, N,N-dimethylformamide and N,N-dimethylacetamide are further preferably used as the organic solvent.

Additionally, in the polyamic acid preparation process, fillers may be added to improve various properties of the film, such as sliding properties, thermal conductivity, corona resistance, loop hardness, and the like. The filler added is not particularly limited, but preferred examples thereof include silica, titanium oxide, alumina, silicon nitride, boron nitride, calcium hydrogen phosphate, calcium phosphate, mica, and the like.

The particle diameter of the filler is not particularly limited but may be determined depending on the properties of a film to be modified and the type of fillers to be added. Typically, the average particle diameter is in a range of 0.05 to 100 μm, which is preferably in the range of 0.1 to 75 μm, more preferably in the range of 0.1 to 50 μm, and even more preferably in the range of 0.1 to 25 μm.

When the particle diameter is smaller than the above range, the modification effect may be challenging to exhibit, and when the particle diameter is larger than the above range, the surface properties may be seriously damaged, or the mechanical properties may significantly deteriorate.

Additionally, the amount of the filler added is not particularly limited but may be determined by the properties of a film to be modified, the particle diameter of the filler, or the like. Typically, the amount of the filler added is in a range of 0.01 to 100 parts by weight with respect to 100 parts by weight of the polyimide, which is preferably in the range of 0.01 to 90 parts by weight and more preferably in the range of 0.02 to 80 parts by weight.

When the amount of the filler added is smaller than the above range, the modification effect by the filler may be challenging to exhibit, and when the amount of the filler added is greater than the above range, the mechanical properties of the film may be seriously damaged. The method of adding the filler is not particularly limited, and any known methods may be used.

In the formation method of the present disclosure, the polyimide film may be formed by a thermal imidization method and a chemical imidization method.

Additionally, the polyimide film may be formed by a complex imidization method in combination of the thermal imidization and chemical imidization methods.

The thermal imidization method is a method of inducing an imidization reaction using a heat source such as an infrared dryer or hot air, without involving a chemical catalyst.

The thermal imidization method may enable the amic acid group present in a gel film to be imidized by subjecting the gel film to heat treatment at a variable temperature in a range of 100° C. to 600° C. Specifically, the heat treatment may be performed at a temperature in a range of 200° C. to 500° C., which is more specifically in the range of 300° C. to 500° C., to imidize the amic acid group present in the gel film.

However, even in the gel film formation process, some of the amic acid (about 0.1 to 10 mol %) may be imidized. To this end, the polyamic acid composition may be dried at a variable temperature in a range of 50° C. to 200° C., which may also fall within the scope of the thermal imidization method.

In the case of the chemical imidization method, a dehydrating agent and an imidizing agent may be used according to methods known in the art to form the polyimide film.

As one example of the complex imidization method, a dehydrating agent and an imidizing agent may be introduced into a polyamic acid solution, heated at a temperature in a range of 80° C. to 200° C., which is preferably in the range of 100° C. to 180° C., partially cured and dried, and then heated at a temperature in a range of 200° C. to 400° C. for 5 to 400 seconds, thereby forming the polyimide film.

On the other hand, the multilayer polyimide film of the present disclosure, described hereinabove, may be formed using one or more methods among co-extrusion or coating.

The co-extrusion method is a method of forming a polyimide film having a multilayer structure by filling a storage tank with a polyamic acid solution or a polyimide resin prepared by imidizing the polyamic acid solution, extruding multiple layers on a casting belt using a co-extrusion die, and then curing the resulting product, which is highly productive and enables high interfacial adhesion reliability to be obtained by mixing types of polyimide resins that differ in interface.

For example, the method of forming the multilayer polyimide film of the present disclosure is performed by including the following steps: firstly filling a first storage tank with a first solution being a first polyamic acid solution or first polyimide resin prepared by imidizing the first polyamic acid solution; secondly filling a second storage tank with a second solution being a second polyamic acid solution or second polyimide resin prepared by imidizing the second polyamic acid solution; extruding the first and second solutions through co-extrusion using a co-extrusion die in which a first flow path connected to the first storage tank, and second and third flow paths each independently connected to the second storage tank are formed; and curing the resulting first and second solutions obtained through the co-extrusion.

The first polyamic acid solution, configured to form the core layer, is preferably prepared by polymerizing an acid dianhydride component including biphenyl-tetracarboxylic dianhydride (BPDA) and pyromellitic dianhydride (PMDA) and a diamine component including para-phenylenediamine (PPD) and m-tolidine.

The second polyamic acid solution, configured to form the skin layer, is preferably prepared by polymerizing an acid dianhydride component including biphenyl-tetracarboxylic dianhydride and pyromellitic dianhydride and a diamine component including para-phenylenediamine, m-tolidine, and oxydianiline (ODA).

On the other hand, when using the first polyamic acid solution as the first solution and the second polyamic acid solution as the second solution, a step of imidizing the resulting first and second solutions obtained through the co-extrusion is preferably further included and performed before the curing step.

The present disclosure provides a flexible metal-clad laminate including the multilayer polyimide film described above and an electrically conductive metal foil.

The metal foil used is not particularly limited. However, when using the flexible metal-clad laminate of the present disclosure for electronic or electrical devices, the metal foil may, for example, include copper or an alloy thereof, stainless steel or an alloy thereof, nickel or an alloy thereof (including Alloy 42), and aluminum or an alloy thereof.

In typical flexible metal-clad laminates, copper foils, such as rolled copper foil and electrolytic copper foil, are widely used and are also preferably used in the present disclosure. Additionally, the surface of such metal foils may be coated with an anti-rust layer, a heat-resistant layer, or an adhesive layer.

The thickness of the metal foil is not particularly limited in the present disclosure and may be any thickness capable of demonstrating sufficient functions depending on the intended use.

The flexible metal-clad laminate, according to the present disclosure, may have a structure in which the metal foil is laminated on one or more of the surfaces of the multilayer polyimide film.

### MODE FOR INVENTION

Hereinafter, the action and effect of the present disclosure will be described in detail through specific examples and preparation examples of the disclosure. However, such examples and preparation examples are provided only for illustrative purposes, and the scope of the present disclosure is not limited to the following examples.

### Preparation Example: Formation of Multilayer Polyimide Film

Biphenyl-tetracarboxylic dianhydride (BPDA), pyromellitic dianhydride (PMDA), para-phenylenediamine (PPD), and m-tolidine (MTD) were allowed to react through block copolymerization reactions to prepare a first polyamic acid solution to be used in the formation of a core layer.

Biphenyl-tetracarboxylic dianhydride, pyromellitic dianhydride, para-phenylenediamine, m-tolidine, and oxydianiline (ODA) were allowed to react through block polymerization reactions to prepare a second polyamic acid solution to be used in the formation of a skin layer.

The components and composition ratios in the core layer and the skin layer are shown in Table 1 below.

TABLE 1

| Core layer | | | | | Skin layer | | | | |
|---|---|---|---|---|---|---|---|---|---|
| Acid dianhydride (mol %) | | Diamine (mol %) | | | Acid dianhydride (mol %) | | Diamine (mol %) | | |
| PMDA | BPDA | ODA | MTD | PPD | PMDA | BPDA | ODA | MTD | PPD |
| 40 | 60 | — | 30 | 70 | 60 | 40 | 15 | 70 | 15 |

The first and second polyamic acid solutions prepared above were extruded through a co-extrusion method, imidized, and then cured to form a three-layer multilayer polyimide film in which, around the core layer, the skin layers were formed respectively on first and second outer surfaces of the core layer, the second outer surface being a surface opposite to the first outer surface.

However, in this case, the core layer was formed by the co-extrusion of the first polyamic acid solution, and the skin layers were formed by the co-extrusion of the second polyamic acid solution.

When preparing the polyamic acid, a solvent used, typically an amide-based solvent, is a polar aprotic solvent, which may be N,N′-dimethylformamide, N,N′-dimethylacetamide, N-methyl-pyrrolidone, or a combination thereof.

The acid dianhydride and diamine components may be introduced in a solution, powder, or lump form. Preferably, the reaction occurs by introducing the components in a powder form at the beginning of the reaction and then in a solution form to control the polymerization viscosity.

The polyamic acid solution obtained in such a manner may be mixed with an imidization catalyst and a dehydrating agent so as to be applied onto a support.

Examples of the catalyst used include tertiary amines (for example, isoquinoline, β-picoline, pyridine, and the like), and examples of the dehydrating agent include anhydrous acids, but the catalyst and the dehydrating agent are not limited thereto.

### Examples and Comparative Examples

While forming the three-layer polyimide film according to the preparation example, the thicknesses of the core layer and the skin layers were adjusted as shown in Table 2 below, thereby forming multilayer polyimide films of Examples 1 to 3 and Comparative Examples 1 to 8.

However, Comparative Examples 1 to 8 correspond to single-layer polyimide films.

TABLE 2

Thickness (μm)

| | Core layer | Skin layer* |
|---|---|---|
| Example 1 | 45 | 5 |
| Example 2 | 40 | 10 |
| Example 3 | 35 | 15 |
| Comparative Example 1 | 50 | 0 |
| Comparative Example 2 | 30 | 20 |
| Comparative Example 3 | 25 | 25 |
| Comparative Example 4 | 20 | 30 |
| Comparative Example 5 | 15 | 35 |
| Comparative Example 6 | 10 | 40 |
| Comparative Example 7 | 5 | 45 |
| Comparative Example 8 | 0 | 50 |

*The thickness of the skin layers in Table 2 corresponds to the total thickness of the skin layers formed on the first and second outer surfaces of the core layer, the second outer surface being the surface opposite to the first outer surface. In other words, this thickness corresponds to the total thickness of the two skin layers. The two skin layers formed are the same in thickness. Accordingly, the thickness of a first skin layer of the multilayer (three-layer) polyimide film of Example 2 is, for example, 5 μm.

*The thickness of the skin layers in Table 2 corresponds to the total thickness of the skin layers formed on the first and second outer surfaces of the core layer, the second outer surface being the surface opposite to the first outer surface. In other words, this thickness corresponds to the total thickness of the two skin layers. The two skin layers formed are the same in thickness. Accordingly, the thickness of a first skin layer of the multilayer (three-layer) polyimide film of Example 2 is, for example, 5 μm.

The dielectric dissipation factor (Df) and adhesive strength of the polyimide film formed in such a manner were measured. The results thereof are shown in Table 3 below.

The methods of measuring the dielectric dissipation factor (Df) and adhesive strength are as follows.

### (1) Measurement of Dielectric Dissipation Factor (Df)

For the dielectric dissipation factor (Df), a sample was dried in an oven at 130° C. for 30 minutes and left for 24 hours in an environment where the relative humidity at 23° C. was 50%. Then, a network analyzer purchased from Keysight and an SPDR resonator purchased from QWED were used to measure a dielectric dissipation factor at 10 GHz.

### (2) Measurement of Adhesive Strength

Regarding the adhesive strength, Innoflex (1 mil, Epoxy type, purchased from Innox) was placed on both surfaces of each polyimide film, and 1 oz copper foil was positioned on both surfaces while placing a protective PI film and raising the temperature to 180° C. Then, heat compression was performed through a pressure of 30 MPa for 1 hour. The resulting film was cut to a size with a 15-mm width and then subjected to a 180° peel test.

TABLE 3

Properties

| | | Adhesive strength |
|---|---|---|
| | Df | (gf/cm) |
| Example 1 | 0.0027 | 1200 |
| Example 2 | 0.0028 | 1200 |
| Example 3 | 0.0029 | 1200 |
| Comparative Example 1 | 0.0025 | 600 |
| Comparative Example 2 | 0.0031 | 1200 |
| Comparative Example 3 | 0.0033 | 1200 |
| Comparative Example 4 | 0.0034 | 1200 |
| Comparative Example 5 | 0.0036 | 1200 |
| Comparative Example 6 | 0.0037 | 1200 |
| Comparative Example 7 | 0.0039 | 1200 |
| Comparative Example 8 | 0.0040 | 1200 |

As a result of the measurement, the multilayer (three-layer) polyimide films of Examples 1 to 3 were characterized by a dielectric dissipation factor of 0.003 or less and an adhesive strength of 1,000 gf/cm or more.

In contrast, the single layer of Comparative Example 1, corresponding to the core layer of the multilayer polyimide film of Examples 1 to 3 and having a thickness of 50 μm, showed a significantly low adhesive strength.

Additionally, Comparative Examples 2 to 7, in which the thickness of the core layer and/or the skin layers was larger or smaller than that of the multilayer polyimide films of Examples 1 to 3, showed an increased dielectric dissipation factor, leading to deterioration in low-dielectric properties.

On the other hand, the single layer of Comparative Example 8, corresponding to the skin layer of the multilayer polyimide film of Examples 1 to 3 and having a thickness of 50 μm, also showed an increased dielectric dissipation factor, leading to deterioration in low-dielectric properties.

Therefore, the multilayer polyimide films of Examples 1 to 3 formed within the appropriate range herein were excellent in both low-dielectric and adhesion properties. However, when formed without falling within the appropriate range herein, it was confirmed that both the low-dielectric and adhesion properties of the multilayer polyimide films herein are challenging to fulfill.

In other words, it was confirmed that the multilayer polyimide film formed within the appropriate range herein was a multilayer polyimide film having excellent low-dielectric and adhesion properties while satisfying various requirements enabling the use thereof in application fields.

The embodiments of the present disclosure regarding the multilayer polyimide film and the formation method thereof are only preferred embodiments that allow those skilled in the art to easily practice the present disclosure in the technical field to which the present disclosure belongs and are not limited to the examples described above. Accordingly, the scope of the present disclosure is not limited thereby. Thus, the true technical protection scope of the present disclosure should be defined by the technical spirit of the appended claims. Additionally, those skilled in the art will appreciate that various modifications, alternatives, and substitutions are possible, without departing from the scope and spirit of the present disclosure as disclosed in the accompanying claims. Furthermore, it is apparent that modifications capable of being easily embodied by those skilled in the art are included within the scope of the present disclosure.

### INDUSTRIAL APPLICABILITY

The present disclosure provides a polyimide film in which the composition ratio, reaction ratio, and the like of acid dianhydride and diamine components are adjusted, thereby providing a polyimide film having both excellent low-dielectric and adhesion properties.

Another objective, according to another aspect of the present disclosure, is to provide a flexible copper-clad laminate including a multilayer polyimide film having excellent adhesive strength and a relatively low dielectric dissipation factor to be effective in high-speed transmission and high-speed communication at high frequencies.

1. A multilayer polyimide film comprising:
a core layer; and
one or more skin layers formed on one or more outer surfaces of the core layer,
wherein a dielectric dissipation factor is 0.003 or less, and an adhesive strength is 1,000 gf/cm or more.

2. The multilayer polyimide film of claim 1, wherein the multilayer polyimide film comprises the skin layers formed respectively on first and second outer surfaces of the core layer, the second outer surface being a surface opposite to the first outer surface, to have a three-layer structure.

3. The multilayer polyimide film of claim 2, wherein the multilayer polyimide film has a total thickness of 10 μm or larger and 100 μm or smaller,
the core layer has a thickness being 70% or more and 95% or less of the total thickness of the multilayer polyimide film, and
the skin layers formed respectively on the first and second outer surfaces of the core layer, the second outer surface being the surface opposite to the first outer surface, has a total thickness being 5% or more and 30% or less of the total thickness of the multilayer polyimide film.

4. The multilayer polyimide film of claim 1, wherein the core layer is obtainable by reacting a polyamic acid solution through an imidization reaction, the polyamic acid solution comprising:
an acid dianhydride component comprising biphenyl-tetracarboxylic dianhydride (BPDA) and pyromellitic dianhydride (PMDA); and
a diamine component comprising para-phenylenediamine (PPD) and m-tolidine.

5. The multilayer polyimide film of claim 1, wherein the skin layer is obtainable by reacting a polyamic acid solution through an imidization reaction, the polyamic acid solution comprising:
an acid dianhydride component including biphenyl-tetracarboxylic dianhydride and pyromellitic dianhydride; and
a diamine component including para-phenylenediamine, m-tolidine, and
oxydianiline (ODA).

6. The multilayer polyimide film of claim 4, wherein the biphenyl-tetracarboxylic dianhydride has a content of 50 mol % or more and 70 mol % or less, and the pyromellitic dianhydride has a content of 30 mol % or more and 50 mol % or less, based on 100 mol % of the total content of the acid dianhydride component, and
the para-phenylenediamine has a content of 60 mol % or more and 80 mol % or less, and the m-tolidine has a content of 20 mol % or more and 40 mol % or less, based on 100 mol % of the total content of the diamine component.

7. The multilayer polyimide film of claim 4, wherein the core layer comprises a block copolymer comprising two or more blocks.

8. The multilayer polyimide film of claim 7, wherein the block copolymer comprises:
a first block comprising 50 mol % or more and 60 mol % or less of the biphenyl-tetracarboxylic dianhydride based on 100 mol % of the total content of the dianhydride component in the polyimide film; and
a second block comprising 30 mol % or more and 40 mol % or less of the m-tolidine based on 100 mol % of the total content of the diamine component in the polyimide film.

9. The multilayer polyimide film of claim 5, wherein the biphenyl-tetracarboxylic dianhydride has a content of 30 mol % or more and 50 mol % or less, and the pyromellitic dianhydride has a content of 50 mol % or more and 70 mol % or less, based on 100 mol % of the total content of the acid dianhydride component, and
the para-phenylenediamine has a content of 5 mol % or more and 25 mol % or less, the m-tolidine has a content of 60 mol % or more and 80 mol % or less, and the oxydianiline has a content of 5 mol % or more and 25 mol % or less, based on 100 mol % of the total content of the diamine component.

10. The multilayer polyimide film of claim 1, wherein the multilayer polyimide film is formed by one or more selected from the group consisting of co-extrusion and coating.

11. A flexible metal-clad laminate comprising:
the multilayer polyimide film of claim 1; and
an electrically conductive metal foil.

12. An electronic component comprising the flexible metal-clad laminate of claim 11.
